(19) United States
(12) Patent Application Publication
(10) Pub. No.: US 2026/0163294 A1
(43) Pub. Date: Jun. 11, 2026

(54) Aviation Connector and Display Screen

(71) Applicant: SHENZHEN GLOSHINE TECHNOLOGY CO., LTD., Shenzhen (CN)

(72) Inventors: Xianfeng Zhang, Shenzhen (CN); Guoqiang Li, Shenzhen (CN); Yongfeng Guo, Shenzhen (CN); Xinyong Chen, Shenzhen (CN)

(21) Appl. No.: 19/056,718

(22) Filed: Feb. 18, 2025

Related U.S. Application Data
(63) Continuation of application No. PCT/CN2024/137734, filed on Dec. 9, 2024.

(30) Foreign Application Priority Data
Dec. 5, 2024 (CN) 202422997903.3

(51) Int. Cl. H01R 13/52; H01R 13/523

(52) U.S. Cl. CPC H01R 13/5202; H01R 13/5213; H01R 13/5219; H01R 13/523; H01R 2201/18; H01R 2201/26

(57) ABSTRACT

Provided are an aviation connector and a display screen. The aviation connector includes an aviation connector main body, which includes a shaft section and an insertion end, at least one end of the shaft section is fixed with the insertion end, and an end face of a side of the insertion end away from the center of the shaft section is a first waterproof surface, which gradually approaches the center of the shaft section from top to bottom, and the first waterproof surface is provided with an insertion port extending along a first direction; and a top surface of the insertion end is a second waterproof surface, the second waterproof surface extends along a second direction, and a height of the second waterproof surface gradually decreases or increases from one end to another end; or, a height of the second waterproof surface gradually decreases from the middle to both ends.

### CROSS REFERENCE TO RELATED APPLICATIONS

The present application is a Continuation Application of PCT Application No. PCT/CN2024/137734 filed on Dec. 9, 2024, which claims the benefit of Chinese Patent Application No. 202422997903.3 filed on Dec. 5, 2024. All the above are hereby incorporated by reference in their entirety.

### TECHNICAL FIELD

The application belongs to the technical field of aviation connectors, in particular to an aviation connector and a display screen.

### BACKGROUND

An aviation connector is one that has the ability to sequentially connect several power or signal lines. It is an essential component of electronic devices, utilized extensively in a variety of electrical circuits, and serves to connect and disconnect circuits.

The large display screen is assembled from multiple unit display screens. Specifically, the unit display screen is connected in series with the aviation connector and then connected in parallel with other unit display screens.

The existing aviation connector connects cables primarily by the plug-in method, with the insertion end directly exposed to the air. In a humid or wet environment, water can easily accumulate on the aviation connector, causing water infiltration and subsequent breakdown.

### SUMMARY OF THE INVENTION

The application provides an aviation connector and a display screen, aiming at addressing the issue that the existing aviation connector is easily infiltrated by water due to collected water and therefore easily broken down.

In order to solve the above technical problems, in one aspect, the embodiment of the application provides an aviation connector, including an aviation connector main body; the aviation connector main body includes a shaft section and an insertion end, at least one end of the shaft section is fixed with the insertion end, and an end face of a side of the insertion end away from the center of the shaft section is a first waterproof surface; the first waterproof surface gradually approaches the center of the shaft section from top to bottom, and the first waterproof surface is provided with an insertion port extending along a first direction; and
a top surface of the insertion end is a second waterproof surface, the second waterproof surface extends along a second direction, and a height of the second waterproof surface gradually decreases or increases from one end to another end; or, a height of the second waterproof surface gradually decreases from the middle to both ends.

Optionally, the first waterproof surface is an inclined surface, an included angle between the first waterproof surface and a vertical plane is α, and 1°≤α≤89°.

Optionally, the first waterproof surface is an inclined surface, and the included angle between the first waterproof surface and a vertical plane is α, and 1°≤α≤10°.

Optionally, the height of the second waterproof surface gradually decreases or increases from one end to another end; the second waterproof surface is an inclined plane, the included angle between the second waterproof surface and a horizontal plane is β, and 7°≤β≤45°; or
the second waterproof surface is an arc surface.

Optionally, the height of the second waterproof surface gradually decreases from the middle to both ends, and the second waterproof surface includes a first surface and a second surface, and the first surface and the second surface converge at the highest point; and
the first surface is inclined or cambered, and the second surface is inclined or cambered.

Optionally, the insertion end is fixed at both ends of the shaft section.

Optionally, a top side of the insertion end is provided with a waterproof eave extending along the second direction, the waterproof eave protrudes from the first waterproof surface in the direction away from the center of the shaft section, and the top surface of the waterproof eave forms the second waterproof surface.

Optionally, the aviation connector further includes a waterproof cover and a connecting belt; the connecting belt connects the shaft section and the waterproof cover, and the waterproof cover is able to cover the insertion port.

Optionally, the waterproof cover includes a cover body and an operating handle; the cover body is circular, and an end face edge of the cover body extends radially outward to form the operating handle.

In another aspect, the embodiment of the application provides a display screen, which includes a plurality of unit display screens and the aviation connector, and cables of the unit display screens are plugged into the insertion port of the aviation connector.

According to the present application, the insertion end of the aviation connector is away from the center of the shaft section, the first waterproof surface gradually approaches the center of the shaft section from top to bottom, the height of the second waterproof surface at the top of the insertion end gradually decreases or increases from one end to another end, or the height of the second waterproof surface gradually decreases from the middle to both ends. Therefore, when water drops on the aviation connector, the water drops on the first waterproof surface can flow downwards and drip along the first waterproof surface, while water drops on the second waterproof surface can flow downwards and drip along the second waterproof surface, preventing water from seeping into the insertion port due to water accumulation on the end surface and top surface of the insertion end. This improves the water-proof performance and safety of the aviation connector.

### BRIEF DESCRIPTION OF DRAWINGS

FIG. 1 is a structural schematic diagram of an aviation connector provided by a first embodiment of the present application.

FIG. 2 is a front view of FIG. 1;

FIG. 3 is an enlarged view of part A in FIG. 2.

FIG. 4 is a side view of FIG. 1.

FIG. 5 is an assembly diagram of the aviation connector in FIG. 1 installed on the unit display screen.

FIG. 6 is a structural schematic diagram of an aviation connector provided by a second embodiment of the present application.

FIG. 7 is a front view of FIG. 6.

FIG. 8 is a side view of FIG. 6.

FIG. 9 is an assembly diagram of the aviation connector in FIG. 6 installed on the unit display screen.

The reference signs in the drawings are as follows:
100. Aviation connector; 1. Aviation connector main body; 11. Shaft section; 12. Insertion end; 13. First waterproof surface; 14. Second waterproof surface; 15. Waterproof eave; 2. Waterproof cover; 21. Operating handle; 3. Connecting belt; 4. Unit display screen.

### DETAILED DESCRIPTION OF THE DISCLOSED EMBODIMENTS

In order to make the technical problems to be solved, technical solutions and beneficial effects of this application more clear, the following is a more complete description of the application, including embodiments and drawings. It should be noted that the specific embodiments described below are simply utilized to clarify the application, not to limit the application.

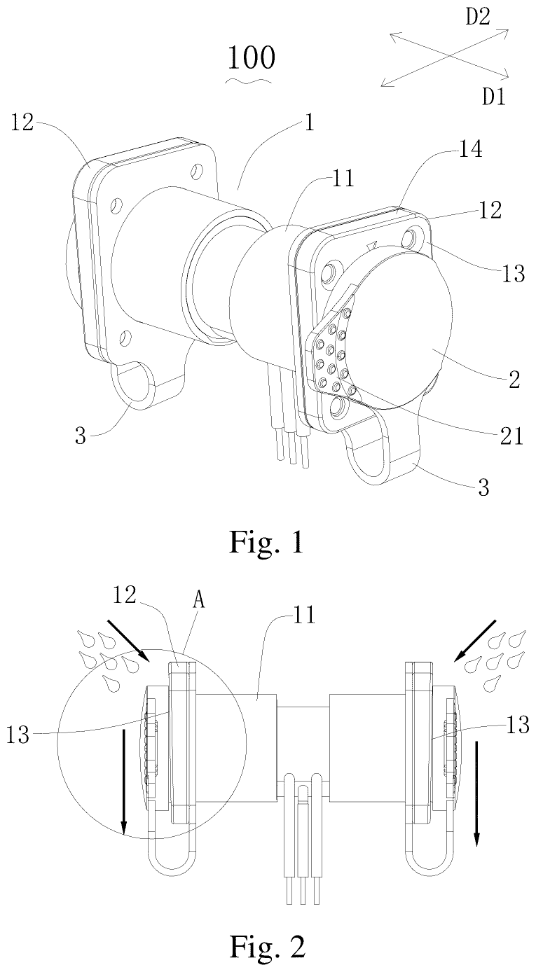

As shown in FIG. 1 to FIG. 3, the first embodiment of the application provides an aviation connector 100, which includes an aviation connector main body 1 including a shaft section 11 and an insertion end 12. At least one end of the shaft section 11 is fixed with an insertion end 12, and the end face of the insertion end 12 on the side away from the center of the shaft section 11 is a first waterproof surface 13. The first waterproof surface 13 gradually approaches the center of the shaft section 11 from top to bottom, and the first waterproof surface 13 is provided with an insertion port extending in the first direction.

As shown in FIG. 1 and FIG. 4, the top surface of the insertion end 12 is a second waterproof surface 14, which extends in the second direction, and the height of the second waterproof surface 14 gradually decreases or increases from one end to another end. Alternatively, the height of the second waterproof surface 14 gradually decreases from the middle to both ends. In FIG. 1, D1 represents the first direction, and D2 represents the second direction.

Therefore, as shown in FIG. 2 and FIG. 4, other liquids such as water drops falling on the first waterproof surface 13 of the insertion end 12 can flow down and drop down along the first waterproof surface 13 in a humid or rainy environment. Other liquids, such as water drops falling on the second waterproof surface 14 of the insertion end 12, can flow to one end of the second waterproof surface 14 with a reduced height and drop, so as to avoid water from seeping into the insertion port due to water accumulation on the end surface and top surface of the insertion end 12. This improves the water accumulation prevention performance and safety of the aviation connector 100. Specifically, the arrow in FIG. 2 indicates the flow direction after water drops on the first waterproof surface 13, and the arrow in FIG. 4 indicates the flow direction after water drops on the second waterproof surface 14.

For the aviation connector 100 of the present application, the insertion end 12 is away from the center of the shaft section 11 and the first waterproof surface 13 gradually approaches the center of the shaft section 11 from top to bottom, the height of the second waterproof surface 14 at the top of the insertion end 12 gradually decreases or increases from one end to another end, or the height of the second waterproof surface 14 gradually decreases from the middle to both ends. Therefore, when water drops on the aviation connector, the water drops on the first waterproof surface 13 can flow downwards and drip along the first waterproof surface 13, while water drops on the second waterproof surface 14 can flow downwards and drip along the second waterproof surface 14, preventing water from seeping into the insertion port due to water accumulation on the end surface and top surface of the insertion end 12. This improves the water-proof performance and safety of the aviation connector 100.

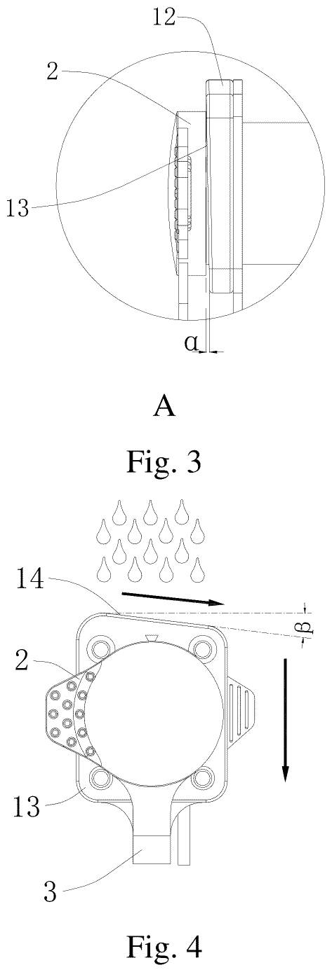

In an embodiment, as shown in FIGS. 2 and 3, the first waterproof surface 13 is an inclined surface, and the included angle between the first waterproof surface 13 and the vertical plane is α, and 1≤α≤89. The greater the included angle between the first waterproof surface 13 and the vertical plane, the more favorable it is for water droplets to flow down along the first waterproof surface 13, and the better the water accumulation prevention effect is.

In an embodiment, the first waterproof surface 13 is an inclined surface, and the included angle between the first waterproof surface 13 and the vertical plane is α, and 1°≤α≤10°. The larger the inclination angle of the first waterproof surface 13, the larger the size of the insertion end 12 along the axial direction of the shaft section 11, and the larger the volume of the aviation connector 100. Therefore, by limiting α in the range of 1°-10°, the aviation connector 100 has the advantages of water-proof performance and relatively small volume.

In one embodiment, the first waterfall surface 13 is an inclined surface, and α is 1°. Apparently, in other embodiments, α may be 5°, 8° and 10°. For an aviation connector 100 with no specific volume, α may also be greater than 10°, such as 12°, 15°, 20°, 30°, 45°, 60°, 80°, 85°, 89° and so on.

In an embodiment, as shown in FIG. 4, the height of the second waterproof surface 14 gradually decreases or increases from one end to another end. The second waterproof surface 14 is an inclined plane, and the included angle between the second waterproof surface 14 and the horizontal plane is β, 7°≤β≤45°.

Because the larger β is, the more favorable it is for water droplets to flow down the second waterproof surface 14, and the better the water accumulation prevention effect is, the larger the vertical dimension of insertion end 12 is, the larger the volume of aviation connector 100 is, and the smaller β is. The more unfavorable it is for the water droplets to flow down the second waterproof surface 14, the worse the water accumulation prevention effect is. The smaller the vertical dimension of the insertion end 12 is, the smaller the size of the aviation connector 100 is. Therefore, by limiting β in the range of 7°-45°, the aviation connector 100 has the advantages of preventing water collection and is relatively small.

In one embodiment, the second waterproof surface 14 is an inclined surface, and β is 7°. Apparently, in other embodiments, β may be 15°, 20°, 35° and 45°. For the aviation connector 100 with no specific volume, β may also be greater than 45°, such as 46°, 50°, 60°, etc.

In an embodiment, the insertion end 12 is fixed at both ends of the shaft section 11.

In an embodiment, it also includes a waterproof cover 2 and a connecting belt 3, the connecting belt 3 connects the shaft section 11 and the waterproof cover 2, and the waterproof cover 2 can cover the insertion port.

Specifically, the insertion port is used to connect the power line or signal line. When the insertion port of the aviation connector 100 is not used, the insertion port is exposed, and impurities such as water or dust can easily enter. Therefore, in this application, the waterproof cover 2 is provided, when the insertion port is not plugged into the power line or signal line, the waterproof cover 2 covers the insertion port.

In one embodiment, both the waterproof cover 2 and connecting belt 3 are made of soft rubber.

In an embodiment, the waterproof cover 2 includes a cover body and an operating handle 21, the cover body is circular, and the end surface edge of the cover body extends radially outward to form the operating handle 21, so that the user can unplug the waterproof cover 2 by the operating handle 21, and the convenience of disassembling the waterproof cover 2 is improved.

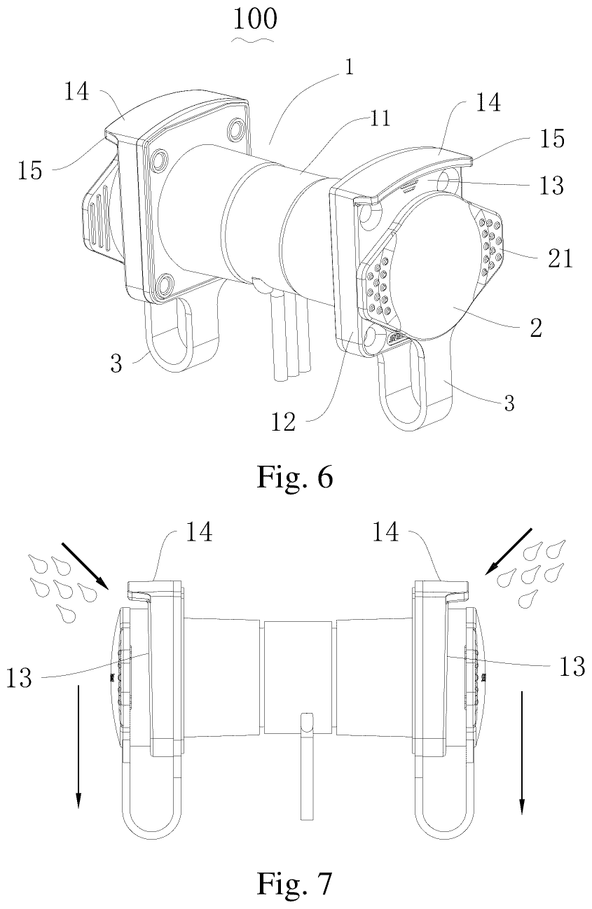

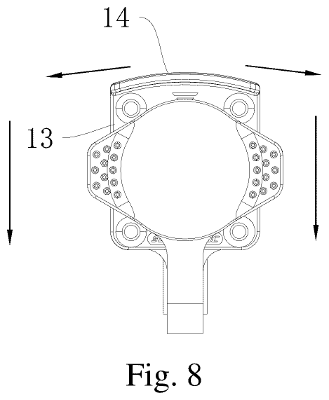

As shown in FIG. 6 to FIG. 8, the second embodiment of the present application also provides an aviation connector 100, which is different from the aviation connector 100 in the first embodiment in that: the second waterproof surface 14 is an arc surface whose height gradually decreases from one end to another end. The arrow in FIG. 7 indicates the flow direction after water drops on the first waterproof surface 13, and the arrow in FIG. 8 indicates the flow direction after water drops on the second waterproof surface 14.

In an embodiment, as shown in FIG. 6, the top side of the insertion end 12 is provided with a waterproof eave 15 extending in the second direction, and the waterproof eave 15 protrudes from the first waterproof surface 13 in the direction away from the center of the shaft section 11, and the top surface of the waterproof eave 15 forms a second waterproof surface 14.

The waterproof eave 15 is positioned at the top side of the insertion port, which can protect the insertion port and first waterproof surface 13 from rain, so as to reduce the possibility of water dripping on the first waterproof surface 13 and the insertion port, and further improve the water-proof performance of aviation connector 100.

In the second embodiment, the top surface of the waterproof eave 15 is a cambered surface. Apparently, in other embodiments, the top surface of the waterproof eave 15 may be inclined.

In other embodiments, the height of the second waterproof surface 14 can gradually decrease from the middle to both ends, and the second waterproof surface 14 includes a first surface and a second surface, and the first surface and the second surface meet at the highest point.

The first surface is inclined or cambered, and the second surface is inclined or cambered.

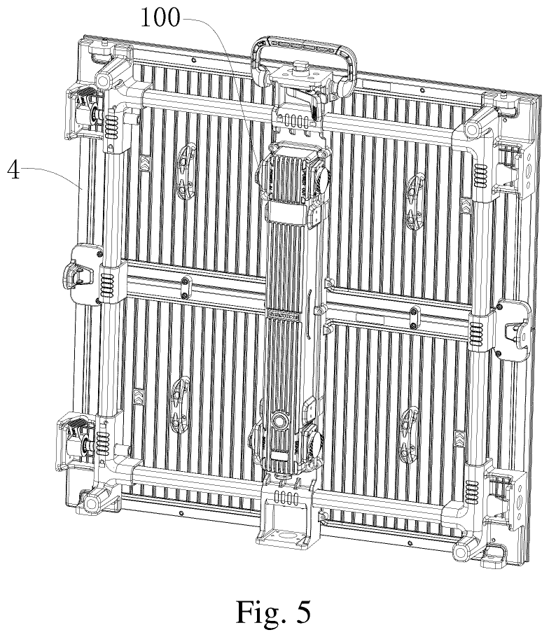

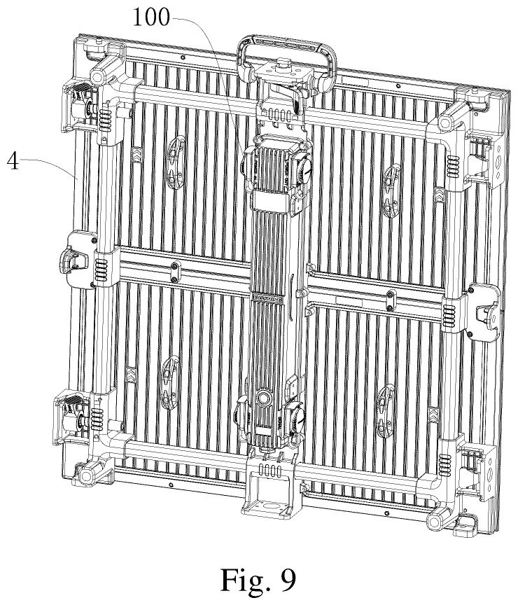

Furthermore, an embodiment of the application provides a display screen, which includes a plurality of unit display screens 4 and the aviation connector 100 described in any of the above embodiments, and the cables of the unit display screens 4 can be plugged into the insertion port of the aviation connector 100. FIG. 5 is a schematic diagram of the aviation connector 100 of the first embodiment installed on the unit display screen 4, and FIG. 9 is a schematic diagram of the aviation connector 100 of the second embodiment installed on the unit display screen 4.

The above are merely the preferred embodiments of this application, and they are not intended to limit it. Any modification, equivalent substitution and improvement made in accordance with the spirit and principles of this application shall be included within the protection scope of this application.

What is claimed is:

1. An aviation connector, comprising an aviation connector main body, wherein the aviation connector main body comprises a shaft section and an insertion end, at least one end of the shaft section is fixed with the insertion end, and an end face of a side of the insertion end away from the center of the shaft section is a first waterproof surface; the first waterproof surface gradually approaches the center of the shaft section from top to bottom, and the first waterproof surface is provided with an insertion port extending along a first direction; and
a top surface of the insertion end is a second waterproof surface, the second waterproof surface extends along a second direction, and a height of the second waterproof surface gradually decreases or increases from one end to another end; or, a height of the second waterproof surface gradually decreases from the middle to both ends.

2. The aviation connector of claim 1, wherein the first waterproof surface is an inclined surface, an included angle between the first waterproof surface and a vertical plane is α, and 1°≤α≤89°.

3. The aviation connector of claim 1, wherein the first waterproof surface is an inclined surface, and the included angle between the first waterproof surface and a vertical plane is α, and 1°≤α≤10°.

4. The aviation connector of claim 1, wherein the height of the second waterproof surface gradually decreases or increases from one end to another end; the second waterproof surface is an inclined plane, the included angle between the second waterproof surface and a horizontal plane is β, and 7°≤β≤45°; or
the second waterproof surface is an arc surface.

5. The aviation connector of claim 1, wherein the height of the second waterproof surface gradually decreases from the middle to both ends, and the second waterproof surface comprises a first surface and a second surface, and the first surface and the second surface converge at the highest point; and
the first surface is inclined or cambered, and the second surface is inclined or cambered.

6. The aviation connector of claim 1, wherein the insertion end is fixed at both ends of the shaft section.

7. The aviation connector of claim 1, wherein a top side of the insertion end is provided with a waterproof eave extending along the second direction, the waterproof eave protrudes from the first waterproof surface in the direction away from the center of the shaft section, and the top surface of the waterproof eave forms the second waterproof surface.

8. The aviation connector of claim 1, further comprising a waterproof cover and a connecting belt, wherein the connecting belt connects the shaft section and the waterproof cover, and the waterproof cover is able to cover the insertion port.

9. The aviation connector of claim 8, wherein the waterproof cover comprises a cover body and an operating handle, wherein the cover body is circular, and an end face edge of the cover body extends radially outward to form the operating handle.

10. A display screen, comprising a plurality of unit display screens and the aviation connector of claim 1, wherein cables of the unit display screens are plugged into the insertion port of the aviation connector.
